(19) United States
(12) Patent Application Publication
(10) Pub. No.: US 2004/0186753 A1
(43) Pub. Date: Sep. 23, 2004

(54) System and method for catastrophic risk assessment

(76) Inventors: David Kim, Webster, NY (US); Gary D'Aquilla, New Hartford, CT (US); Robert Lin, Lynchburg, VA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/393,461

(22) Filed: Mar. 21, 2003

(51) Int. Cl. G06F 17/60

(52) U.S. Cl. 705/4

(57) ABSTRACT

The present invention provides a system and methodology for quantification of insurance risks from a variety of catastrophic events in one or more geographic locations. A probability distribution for a given catastrophic event is developed. A potential claim distribution of the given event is developed. A geographic distribution of an insurance company's issued policies related to the event is developed. Probabilistic models are built and stochastic simulations carried out to quantify the company's insurance risk due to the catastrophic event. The assessment may be in the form of expected insurance payout, a stated risk level and/or net income impact. Decisions can then be made, based on the invention results, to adjust the related policy premiums or to purchase third-party reinsurance protection against the catastrophic event.

### BACKGROUND OF THE INVENTION

The present invention relates to the field of insurance risk assessment. More particularly, the present invention relates to assessment of insurance risks from catastrophic events.

A catastrophic event is a natural or man-made event that involves a tremendous loss of human lives and properties. Examples of natural catastrophes include earthquakes, hurricanes, and tornadoes etc. One example of man-made event is a terrorist attack, which may involve weapons of mass destruction, such as nuclear, biological or chemical weapons. Other examples of man-made catastrophes may include plane-crashes or train-derailing.

Due to low historical frequency of catastrophic events in the Life Insurance Industry, Life insurance companies usually do not factor such risk into the calculation of insurance premiums. However, a catastrophic event may have a tremendous financial impact. Usually, insurance premiums are calculated based on an expected claim cost plus administrative expense cost plus some profit margin based on historical experience. For example, if the company processed a high-death-toll event in the history, it would be priced into the premiums on an individual basis. Catastrophic events, in contrast, represent exposure on the tail of the claims model—far from the traditional expected value.

In the rare cases when a catastrophe does strike, the potential financial losses could have a crippling effect on an unprepared insurance company. Especially when the policy holders are concentrated in high-risk areas, it is important for the policy issuers to anticipate and understand their exposure to a catastrophic event.

For protection against overwhelming claims, an insurance company may choose to shift a portion of its liability by purchasing reinsurance from a third party. In order to decide whether to purchase reinsurance and how much to purchase, the insurance company needs to understand, in a quantitative manner, the insurance risks it is exposed to. On the other hand, a reinsurance issuer should also understand the insurance risks of its clients. However, there has not been a systematic approach to quantify reinsurance needs for catastrophic risks.

Other drawbacks may also exist.

### BRIEF SUMMARY OF THE INVENTION

Accordingly, the present invention is directed to a system and method for catastrophic risk assessment that overcomes these and other drawbacks of present systems and methods.

It is an object of the present invention to provide a systematic approach to quantify the amount of insurance issuer's risk associated with catastrophic events.

It is another object of the present invention to provide a quantitative understanding of the impact on an insurance company's net income as a result of catastrophic events.

It is yet another object of the present invention to provide a basis for adjusting insurance premiums and/or for assessing the needs and level of reinsurance, in anticipation of catastrophic events.

Additional objects of the invention will be set forth in part in the description, or may be learned by practice of the invention. The advantages of the invention may be realized and attained by means of instrumentalities and combinations particularly pointed out in the appended claims and are not limited to those described above.

To achieve these objects and in accordance with the purpose of the invention, as embodied and broadly described herein, a method for assessing an insurance company's risk due to a plurality of catastrophic events includes determining a probability distribution for at least one catastrophic event occurring in at least one geographic location, determining a potential claim rate due to the at least one catastrophic event occurring in the at least one geographic location, acquiring information related to the insurance company's issued insurance policies within the at least one geographic location, and computing a probability distribution of expected insurance payout by the insurance company due to the at least one catastrophic event occurring in the at least one geographic location.

In another aspect, a computer usable medium having computer readable program code embodied therein for assessing an insurance company's risk due to a plurality of catastrophic events provides code for determining a probability distribution for at least one catastrophic event occurring in at least one geographic location, code for determining a potential claim rate due to the at least one catastrophic event occurring in the at least one geographic location, code for acquiring information related to the insurance company's issued insurance policies within the at least one geographic location, and code for computing a probability distribution of expected insurance payout by the insurance company due to the at least one catastrophic event occurring in the at least one geographic location.

In yet another aspect, a system for assessing an insurance company's risk due to a plurality of catastrophic events includes means for determining a probability distribution for at least one catastrophic event occurring in at least one geographic location, means for determining a potential claim rate due to the at least one catastrophic event occurring in the at least one geographic location, means for acquiring information related to the insurance company's issued insurance policies within the at least one geographic location, and means for computing a probability distribution of expected insurance payout by the insurance company due to the at least one catastrophic event occurring in the at least one geographic location.

In a further aspect, a system for assessing an insurance company's risk due to a plurality of catastrophic events provides a first determination module for determining a probability distribution for at least one catastrophic event occurring in at least one geographic location, a second determination module for determining a potential claim rate due to the at least one catastrophic event occurring in the at least one geographic location, an acquisition module for acquiring information related to the insurance company's issued insurance policies within the at least one geographic location, and a computation module for computing a probability distribution of expected insurance payout by the insurance company due to the at least one catastrophic event occurring in the at least one geographic location.

It is understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate an embodiment of the invention and, together with the description, serve to explain the principles of the invention.

FIG. 1 is a flowchart illustrating steps in a method for assessing catastrophic risk according to an embodiment of the invention.

FIG. 2 is a histogram of a typical probability distribution for occurrence of at least one catastrophic event according to an embodiment of the invention. (hereafter referred to Pᵢ)

FIG. 3 is a histogram of a typical probability distribution for loss of lives according to one embodiment of the invention. (hereafter referred to Lᵢ)

FIG. 4 is a histogram of a typical probability distribution for geographic distribution or policy face amounts according to one embodiment of the invention. (hereafter referred to Faᵢ)

FIG. 5 is a frequency chart that reflects the computation results of a hypothetical stochastic simulation according to one embodiment of the invention. (hereafter referred to Eᵢ)

FIG. 6 is a schematic representation of a system for assessing catastrophic risk according to an embodiment of the invention.

### DETAILED DESCRIPTION OF THE INVENTION

Reference will now be made in detail to the present embodiments of the invention, examples of which are illustrated in the accompanying drawings.

As described herein, a technical effect of the invention is to provide a system and method for quantifying and assessing an insurance company's risk due to the occurrence of at least one catastrophic event. What follows is a description of features and aspects of the invention that further detail this and other technical effects.

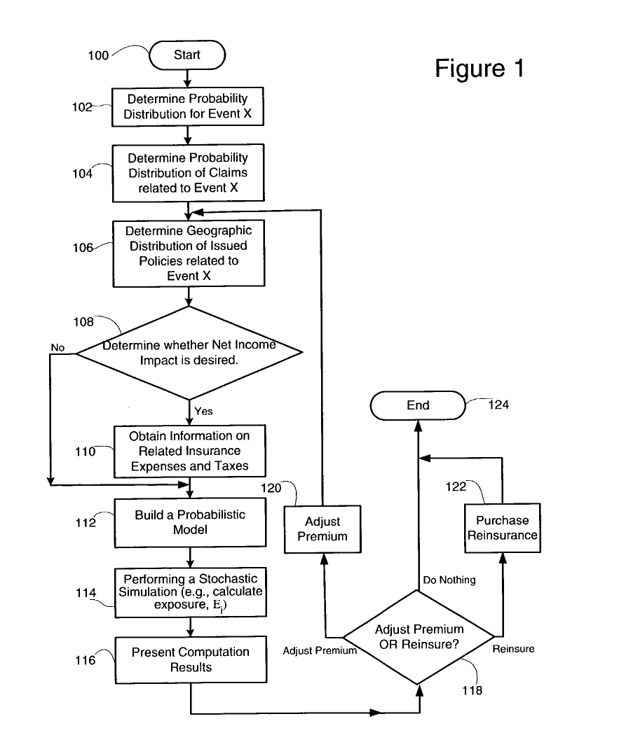

FIG. 1 is a flowchart illustrating steps in a method for assessing catastrophic risk according to an embodiment of the invention.

The process starts at step 100.

At step 102, the probability distribution of a catastrophic event, Pi, is determined. By way of example, the catastrophic event may be a natural disaster such as an earthquake, a hurricane, or a tornado. The catastrophic event may also be a man-made event, for example, a terrorist attack. The catastrophic event may also be a combination of the above-mentioned natural and man-made events. For illustration purposes, this catastrophic event is called Event X from here on. For illustrative purposes, a strong earthquake in the San Francisco Bay Area (or the Bay Area) is referenced as one example of Event X in the following description.

According to one embodiment of the invention, a probability distribution of a natural catastrophic event may be obtained from empirical frequency data from government agencies such as the United States Geological Survey (USGS) and the National Oceanic and Atmospheric Administration (NOAA). For example, earthquake data may be available from USGS databases and hurricane and tornado data may be extracted from NOAA databases. This information may also be acquired from private resources such as relevant databases maintained by universities or other private research institutions. This probability distribution may provide information on the probability or frequency of occurrence of a particular natural event at a particular geographic location. The probability distribution information may be in the form of raw data, empirical formula or look up tables. Information on man-made catastrophic events may also be obtained from records maintained by private organizations or government agencies. One example of such a government agency is the Federal Emergency Management Agency (FEMA) and their local and state equivalent. To generate a realistic probability distribution of a man-made catastrophe, historic records may be referenced together with consideration of one or more factors. For example, the probability of a terrorist attack on a major U.S. city may be estimated from historic records of such attacks, with consideration of economic and political importance of this city and the nation's foreign relations at the time of interest. At step 102, such information is analyzed and standardized for computation needs.

By way of example, to determine the probability of an earthquake in the Bay area, the United States Geological Survey (USGS) databases may be searched for any records of past earthquakes in the Bay Area, as well as other records of geological changes, such as crust or mantle movements, that may be relevant in predicting an earthquake in the area of interest. The historical record of earthquakes may help generate a frequency of occurrence table that may be further modified, with new geological discoveries taken into account, and converted into a standardized mathematical representation.

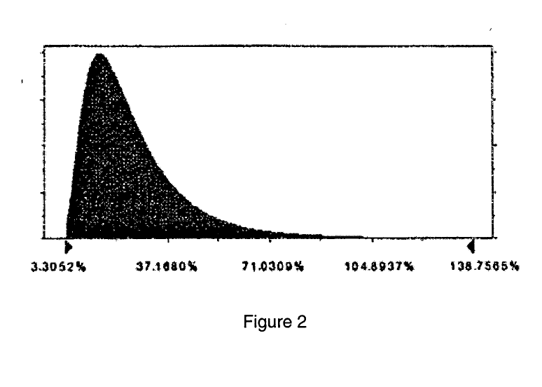

FIG. 2 illustrates a histogram of a typical probability distribution for an earthquake, for example. The x-axis of the graph corresponds to the probability that an earthquake is likely to occur. The y-axis, on the other hand, corresponds to the likelihood that a particular occurrence probability will be realized. As shown, the greatest likelihood is that an earthquake will occur between a 3.3052% and 37.1680% probability distribution. As stated above, the histogram may be constructed using information readily available through numerous sources, such as government agencies, offices, and departments. Other sources are of course possible.

At step 104, the probability distribution of claims or the potential claim rate for Event X is determined. The probability distribution is based on the historical data fitted to best describe the characteristics of the data. If Event X happens to be a combination of events, information on potential claim rate for each component event of Event X may be combined to generate a combined probability distribution.

Depending on the type of insurance policies, the claim rate may be related to damage of property or loss of lives. For a life insurance issuer, the potential claim rate may be directly linked with a loss of life probability distribution, Li. According to an embodiment of the invention, the loss of life probability distribution may be extracted from historical death rate sources such as the United States Geological Survey (USGS) and the National Oceanic and Atmospheric Administration (NOAA). Claim rates related to property damages and loss of lives may also be extracted from records maintained by federal and local emergency management agencies or other sources.

Again, with the Bay Area earthquake as an example, it may be desirable for an issuer of property and casualty insurance policies to determine the potential claim rates related to the collapsing of living structures, damaging of vehicles and loss of lives. For example, based on historical records, the potential number of lives lost may be determined in relation to the epicenter location and severity of the earthquake. According to one embodiment of the invention, the loss of life probability distribution of an earthquake may be represented as a Weibull distribution with the 1906 San Francisco Earthquake death toll as a mean value.

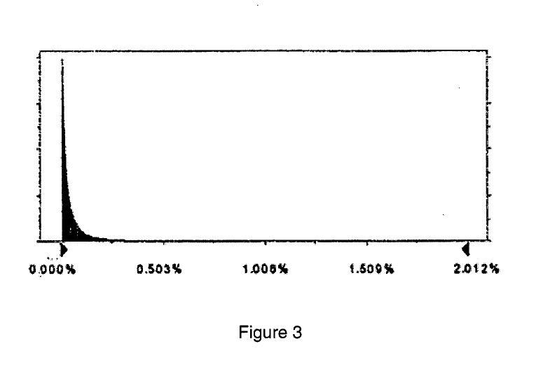

FIG. 3 illustrates a histogram of a typical probability distribution for loss of lives, Li. The x-axis of the graph corresponds to the probability that loss of life will occur. The y-axis, on the other hand, corresponds to likelihood that a particular loss of life probability will be realized. As shown, the greatest likelihood is that expected loss of life will occur somewhere very close to zero. As stated above, the histogram may be constructed using information readily available through numerous sources, such as government agencies, offices, and departments. Other sources are of course possible.

At step 106, a geographic distribution, Fai, of an insurance company's issued policies related to Event X is determined. Such information may include the policy-holders' geographic locations, policy premiums, policy payout amounts should Event X occur, etc. This information may be readily available from the company's customer database. Additional manipulation of the data may be necessary to generate the distribution in an appropriate format for further computation needs.

In the example of the Bay Area earthquake, it may be desirable to determine the geographic locations of the insured (within the Bay Area), the amount of premiums they paid for protection against an earthquake, and the compensation they are entitled to receive from the insurance company in the event of an earthquake. Since an earthquake is a position-sensitive event, geographic distribution of the insured may greatly influence the insurance company's payout due to an earthquake.

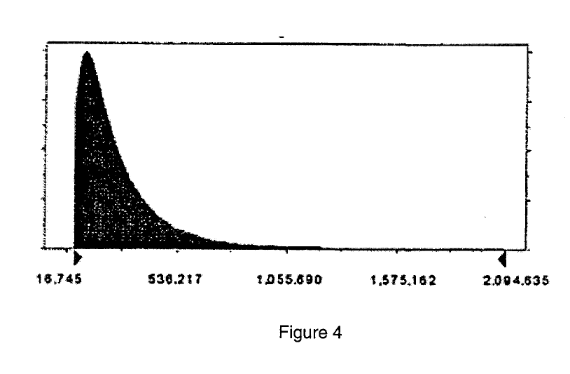

FIG. 4 illustrates a histogram of a typical geographic distribution, Fai. According to one embodiment, the geographic distribution may be based on policy face amount. The x-axis of the graph corresponds to the total face value policy amount should an event occur. The y-axis, on the other hand, corresponds to likelihood that a particular total face value amount will be realized. As shown, the greatest likelihood is that expected policy face value amounts will be between $16,745 and $275,000. As stated above, the histogram may be constructed using information readily available through numerous sources, such as government agencies, offices, and departments. Other sources are of course possible.

The process branches at step 108, depending on whether the Net Income Impact by Event X needs to be calculated (i.e., whether there is interest in determining the income impact of the exposure, or just the overall exposure. If it is desired, additional information of related insurance expenses and taxes may be obtained at step 110. The information may then be compared to the estimated exposure, Ej, to determine the overall effect on income, i.e., the bottom line effect of exposure.

At step 112, a probabilistic model is built based on the information collected at the previous steps. The probabilistic model may reflect the estimated exposure, Ej, to an insurance company, for example, based on probability distributions reflected in FIGS. 2-4, for example. In one embodiment, the following formula may be used to determine the probabilistic model:

$${E}_{j} = {\sum }_{j}^{} {P}_{i} ⋆ {\sum }_{j}^{} {L}_{i} ⋆ {\sum }_{j}^{} F {a}_{i}$$

where,

Ej=Probability Distribution of Expected Payout by the Insurance Company,

Pi=Probability Distribution of Catastrophic Event,

Li=Probability Distribution of Loss of Life, and

Fai=Probability Distribution of geographic locations or Policy Face Amounts

At step 114, a stochastic simulation is performed using the probabilistic model. A stochastic simulation is a simulation of a series of random processes, each of which may depend on its previous process and on further random choices. The uncertain nature of a catastrophic event and its consequent effects may be most realistically mimicked in a stochastic simulation.

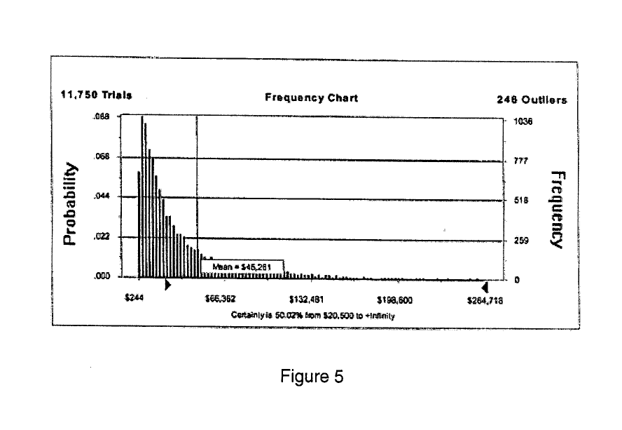

FIG. 5 illustrates one embodiment of a frequency chart that reflects the computation results of a hypothetical stochastic simulation. As shown, a mean value of $45,261 indicates, for example, the average policy losses that would properly account for the likely occurrence of a catastrophic event. In the example shown, the chart was constructed by running 11,750 trials of each trial providing different values for the corresponding variables Ei, Li, Fai, as obtained from the respective charts in FIGS. 2, 3 and 4, for example.

At step 116, the computation results from the stochastic simulation is presented to the user, in the form of expected payout and/or net income impact, for example. Based on the results, further decisions may be made at step 118.

By way of example, there are at least a few options for the insurance company.

If the total of collected premiums is not enough to cover expected payout, the insurance issuers may choose to adjust the insurance premiums for the policies that cover Event X. However, adjusted premiums may change customer behavior related to the corresponding policies. For example, a raised premium may discourage some customers from continuing purchasing the corresponding policy. Therefore, the geographic distribution of issued policies may need reevaluation. Thus, if a decision is made to adjust the premiums, the process will branch to step 120 to adjust the premium and then to step 106 to re-determine a geographic distribution of issued policies based on the new premiums, and reassess the insurance risk due to Event X.

If the net income impact on the insurance company is too much, they may choose to purchase third-party reinsurance protection against overwhelming claims related to Event X, at step 122. Alternatively, they may choose to adjust premiums and reinsure, or may choose to do nothing. By way of another example, if this method is being used by a third party who issues reinsurance policies, this third party may decide whether to issue such a reinsurance policy to protect a client company against claims associated Event X, and what the required level of reinsurance level is required.

The process ends at step 124.

According to an embodiment of the invention, a computer-usable and writeable medium having a plurality of computer readable program code stored therein may be provided for practicing the process of the present invention described above. The process and system of the present invention may be implemented within a variety of operating systems, such as a Windows® operating system, various versions of a Unix-based operating system (e.g., a Hewlett Packard, a Red Hat, or a Linux version of a Unix-based operating system), or various versions of an AS/400-based operating system. For example, the computer-usable and writeable medium may be comprised of a CD ROM, a floppy disk, a hard disk, or any other computer-usable medium.

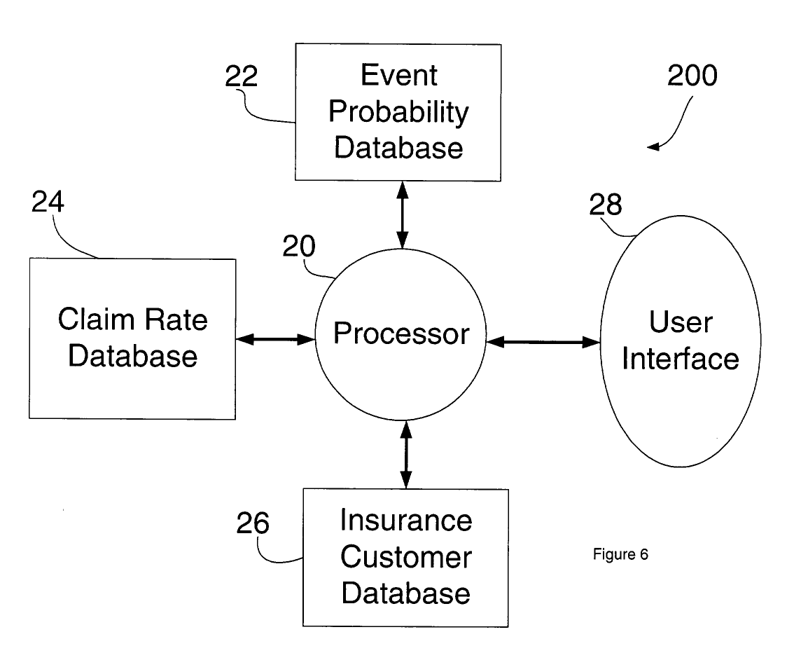

FIG. 6 is a schematic representation of a System 200 for assessing catastrophic risk according to an embodiment of the invention. The system comprises a Processor 20, an Event Probability Database 22, a claim Rate Database 24, an Insurance Customer Database 26, and a User Interface 28.

According to an embodiment of the invention, the System 200 may be implemented on computer(s) or a computer-based network. The Processor 20 may be a computer capable of data manipulation, probability computation and stochastic modeling. According to an embodiment of the invention, the computer may be a standard computer comprising an input device, an output device, a processor device, and a data storage device. The Event Probability Database 22 may be a plurality of databases containing data records and/or probability distribution of a number of natural and man-made catastrophic events. The claim Rate Database 24 may be a plurality of databases containing historical records of death rate and/or computed loss of lives probability distribution for catastrophic events. The Insurance Customer Database 26 may be a plurality of databases containing information on the geographic locations of an insurance company's policy-holders, policy premiums, policy payout amounts etc. The User Interface module 28 may be a graphical user interface (GUI) serving the purpose of obtaining inputs from and presenting results to a user of the system. According to embodiments of the invention, the User Interface module may be a display, such as a CRT, LCD or touch-screen monitor, or a computer terminal, or a personal computer connected to the Processor 20.

According to one specific embodiment of the present invention, the system may comprise components of a software system. The system may operate on a network and may be connected to other systems sharing a common database. Other hardware arrangements may also be provided.

By way of example, the operation of System 200 for catastrophic risk assessment will now be described, according to one embodiment of the present invention.

A user of System 200 may submit a request through the User Interface module 28. The request may be for the expected payout or net income impact due to a specific type of catastrophe or a combination of events. According to an embodiment of the invention, the request may be directed to a portion of the policy-holders located in high risk areas, or it may be directed to all policy-holders in all areas.

The Processor 20 receives input from the user and starts to obtain relevant information based on the request. It may identify the specific events of interest and make queries to databases 22, 24 and 26. It may obtain event probability distribution of specific events or their combination from Event Probability Database 22. It may obtain potential claim rate for the specific events from claim Rate Database 24. And it may obtain related policy distribution information from Insurance Customer Database 26.

Next, the Processor 20 runs a stochastic modeling to compute the risk assessment information requested by the user. Different computational models may be adopted to generate the results. The results are then output to the User Interface 28 to present to the user. The user may then make decisions about life insurance premiums and reinsurance needs etc., based on the results.

Other embodiments, uses and advantages of the present invention will be apparent to those skilled in the art from consideration of the specification and practice of the invention disclosed herein.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A method for assessing an insurance company's risk due to a plurality of catastrophic events, the method comprising
determining a probability distribution for at least one catastrophic event occurring in at least one geographic location;
determining a potential claim rate due to the at least one catastrophic event occurring in the at least one geographic location;
acquiring information related to the insurance company's issued insurance policies within the at least one geographic location; and
computing a probability distribution of expected insurance payout by the insurance company due to the at least one catastrophic event occurring in the at least one geographic location.

2. The method according to claim 1, wherein the computed probability distribution of expected insurance payout is based on at least one of:
the probability distribution for the at least one catastrophic event occurring in the at least one geographic location;
potential claim rate due to the at least one catastrophic event occurring in the at least one geographic location; and
the information related to the insurance company's issued life insurance policies.

3. The method according to claim 1, wherein the insurance company's issued insurance policies are life insurance policies.

4. The method according to claim 1, wherein the plurality of catastrophic events comprising at least one of:
a) an earthquake;
b) a hurricane;
c) a tornado;
d) a terrorist attack;
e) other natural or man-made event that involves loss of properties or human lives.

5. The method according to claim 1, wherein computing a probability distribution of expected insurance payout by the insurance company further comprising
building a probabilistic model; and
performing a stochastic simulation based on the probabilistic model.

6. The method according to claim 1, further comprising generating a presentation of the probability distribution of expected insurance payout by the insurance company due to the at least one catastrophic event occurring in the at least one geographic location.

7. The method according to claim 1, further comprising adjusting insurance premiums, based on the probability distribution of expected insurance payout by the insurance company due to the at least one catastrophic event occurring in the at least one geographic location.

8. The method according to claim 1, further comprising purchasing reinsurance protection against the at least one catastrophic event, based on the probability distribution of expected insurance payout by the insurance company due to the at least one catastrophic event occurring in the at least one geographic location.

9. The method according to claim 1, further comprising
acquiring information related to insurance expenses and taxes, wherein the insurance expenses and taxes are associated with the at least one catastrophic event occurring in the at least one geographic location;
computing an impact on the insurance company's net income due to the at least one catastrophic event occurring in the at least one geographic location.

10. The method according to claim 9, further comprising generating a presentation of the impact on the insurance company's net income due to the at least one catastrophic event occurring in the at least one geographic location.

11. The method according to claim 9, further comprising adjusting insurance premiums, based on the impact on the insurance company's net income due to the at least one catastrophic event occurring in the at least one geographic location.

12. The method according to claim 9, further comprising determining the required level of reinsurance protection and purchasing the aforementioned protection against the least one catastrophic event, based on the impact on the insurance company's net income due to the at least one catastrophic event occurring in the at least one geographic location.

13. A computer usable medium having computer readable program code embodied therein for assessing an insurance company's risk due to a plurality of catastrophic events, said computer readable program code comprising
code for determining a probability distribution for at least one catastrophic event occurring in at least one geographic location;
code for determining a potential claim rate due to the at least one catastrophic event occurring in the at least one geographic location;
code for acquiring information related to the insurance company's issued insurance policies within the at least one geographic location; and
code for computing a probability distribution of expected insurance payout by the insurance company due to the at least one catastrophic event occurring in the at least one geographic location.

14. The computer usable medium according to claim 13, wherein the computed probability distribution of expected insurance payout is based on at least one of:
the probability distribution for the at least one catastrophic event occurring in the at least one geographic location;
potential claim rate due to the at least one catastrophic event occurring in the at least one geographic location; and
the information related to the insurance company's issued life insurance policies.

15. The computer usable medium according to claim 13, wherein the insurance company's issued insurance policies are life insurance policies.

16. The computer usable medium according to claim 13, wherein the plurality of catastrophic events comprising at least one of:
a) an earthquake;
b) a hurricane;
c) a tornado;
d) a terrorist attack;
e) other natural or man-made event that involves loss of properties or human lives.

17. The computer usable medium according to claim 13, wherein the code for computing a probability distribution of expected insurance payout by the insurance company further comprising
code for building a probabilistic model; and
code for performing a stochastic simulation based on the probabilistic model.

18. The computer usable medium according to claim 13, further comprising code for generating a presentation of the probability distribution of expected insurance payout by the insurance company due to the at least one catastrophic event occurring in the at least one geographic location.

19. The computer usable medium according to claim 13, further comprising code for adjusting insurance premiums, based on the probability distribution of expected insurance payout by the insurance company due to the at least one catastrophic event occurring in the at least one geographic location.

20. The computer usable medium according to claim 13, further comprising code for purchasing reinsurance protection against the at least one catastrophic event, based on the probability distribution of expected insurance payout by the insurance company due to the at least one catastrophic event occurring in the at least one geographic location.

21. The computer usable medium according to claim 13, further comprising
code for acquiring information related to insurance expenses and taxes, wherein the insurance expenses and taxes are associated with the at least one catastrophic event occurring in the at least one geographic location;
code for computing an impact on the insurance company's net income due to the at least one catastrophic event occurring in the at least one geographic location.

22. The computer usable medium according to claim 21, further comprising code for generating a presentation of the impact on the insurance company's net income due to the at least one catastrophic event occurring in the at least one geographic location.

23. The computer usable medium according to claim 21, further comprising code for adjusting insurance premiums, based on the impact on the insurance company's net income due to the at least one catastrophic event occurring in the at least one geographic location.

24. The computer usable medium according to claim 21, further comprising determining the required level of reinsurance protection and purchasing the aforementioned protection against the least one catastrophic event, based on the impact on the insurance company's net income due to the at least one catastrophic event occurring in the at least one geographic location.

25. A system for assessing an insurance company's risk due to a plurality of catastrophic events, the system comprising
means for determining a probability distribution for at least one catastrophic event occurring in at least one geographic location;
means for determining a potential claim rate due to the at least one catastrophic event occurring in the at least one geographic location;
means for acquiring information related to the insurance company's issued insurance policies within the at least one geographic location; and
means for computing a probability distribution of expected insurance payout by the insurance company due to the at least one catastrophic event occurring in the at least one geographic location.

26. The system according to claim 25, wherein the computed probability distribution of expected insurance payout is based on at least one of:
the probability distribution for the at least one catastrophic event occurring in the at least one geographic location;
potential claim rate due to the at least one catastrophic event occurring in the at least one geographic location; and
the information related to the insurance company's issued life insurance policies.

27. The system according to claim 25, wherein the insurance company's issued insurance policies are life insurance policies.

28. The system according to claim 25, wherein the plurality of catastrophic events comprising at least one of:
a) an earthquake;
b) a hurricane;
c) a tornado;
d) a terrorist attack;
e) other natural or man-made event that involves loss of properties or human lives.

29. The system according to claim 25, wherein the means for computing a probability distribution of expected insurance payout by the insurance company further comprising
means for building a probabilistic model; and
means for performing a stochastic simulation based on the probabilistic model.

30. The system according to claim 25, further comprising means for generating a presentation of the probability distribution of expected insurance payout by the insurance company due to the at least one catastrophic event occurring in the at least one geographic location.

31. The system according to claim 25, further comprising means for adjusting insurance premiums, based on the probability distribution of expected insurance payout by the insurance company due to the at least one catastrophic event occurring in the at least one geographic location.

32. The system according to claim 25, further comprising means for determining the required level of reinsurance protection and purchasing the aforementioned protection against the at least one catastrophic event, based on the probability distribution of expected insurance payout by the insurance company due to the at least one catastrophic event occurring in the at least one geographic location.

33. The system according to claim 25, further comprising
means for acquiring information related to insurance expenses and taxes, wherein the insurance expenses and taxes are associated with the at least one catastrophic event occurring in the at least one geographic location;
means for computing an impact on the insurance company's net income due to the at least one catastrophic event occurring in the at least one geographic location.

34. The system according to claim 33, further comprising means for generating a presentation of the impact on the insurance company's net income due to the at least one catastrophic event occurring in the at least one geographic location.

35. The system according to claim 33, further comprising means for adjusting insurance premiums, based on the impact on the insurance company's net income due to the at least one catastrophic event occurring in the at least one geographic location.

36. The system according to claim 33, further comprising means for purchasing reinsurance protection against the least one catastrophic event, based on the impact on the insurance company's net income due to the at least one catastrophic event occurring in the at least one geographic location.

37. A system for assessing an insurance company's risk due to a plurality of catastrophic events, the system comprising
a first determination module for determining a probability distribution for at least one catastrophic event occurring in at least one geographic location;
a second determination module for determining a potential claim rate due to the at least one catastrophic event occurring in the at least one geographic location;
an acquisition module for acquiring information related to the insurance company's issued insurance policies within the at least one geographic location; and
a computation module for computing a probability distribution of expected insurance payout by the insurance company due to the at least one catastrophic event occurring in the at least one geographic location.

38. The system according to claim 37, wherein the computed probability distribution of expected insurance payout is based on at least one of:
the probability distribution for the at least one catastrophic event occurring in the at least one geographic location;
potential claim rate due to the at least one catastrophic event occurring in the at least one geographic location; and
the information related to the insurance company's issued life insurance policies.

39. The system according to claim 37, wherein the insurance company's issued insurance policies are life insurance policies.

40. The system according to claim 37, wherein the plurality of catastrophic events comprising at least one of:
a) an earthquake;
b) a hurricane;
c) a tornado;
d) a terrorist attack;
e) other natural or man-made event that involves loss of properties or human lives.

41. The system according to claim 37, wherein the computation module for computing a probability distribution of expected insurance payout by the insurance company further comprising
a building module for building a probabilistic model; and
a simulation module for performing a stochastic simulation based on the probabilistic model.

42. The system according to claim 37, further comprising a generation module for generating a presentation of the probability distribution of expected insurance payout by the insurance company due to the at least one catastrophic event occurring in the at least one geographic location.

43. The system according to claim 37, further comprising an adjusting module for adjusting insurance premiums, based on the probability distribution of expected insurance payout by the insurance company due to the at least one catastrophic event occurring in the at least one geographic location.

44. The system according to claim 37, further comprising a purchasing module for purchasing reinsurance protection against the at least one catastrophic event, based on the probability distribution of expected insurance payout by the insurance company due to the at least one catastrophic event occurring in the at least one geographic location.

45. The system according to claim 37, further comprising
a acquisition module for acquiring information related to insurance expenses and taxes, wherein the insurance expenses and taxes are associated with the at least one catastrophic event occurring in the at least one geographic location;
a computation module for computing an impact on the insurance company's net income due to the at least one catastrophic event occurring in the at least one geographic location.

46. The system according to claim 45, further comprising a generation module for generating a presentation of the impact on the insurance company's net income due to the at least one catastrophic event occurring in the at least one geographic location.

47. The system according to claim 45, further comprising an adjusting module for adjusting insurance premiums, based on the impact on the insurance company's net income due to the at least one catastrophic event occurring in the at least one geographic location.

48. The system according to claim 45, further comprising a purchasing module for determining the required level of reinsurance protection and purchasing the aforementioned protection against the least one catastrophic event, based on the impact on the insurance company's net income due to the at least one catastrophic event occurring in the at least one geographic location.
